(19) United States
(12) Patent Application Publication
(10) Pub. No.: US 2002/0150040 A1
(43) Pub. Date: Oct. 17, 2002

(54) Partial puncture retransmission

(76) Inventors: Wen Tong, Ottawa (CA); Catherine Leretaille-Gauthier, Paris (FR); Mo-Han Fong, L'Orignal (CA); Bastien Massie, Paris (FR); Evelyne Le Strat, Paris (FR)

Correspondence Address: WITHROW & TERRANOVA, P.L.L.C., P.O. BOX 1287, CARY, NC, 27512, US

(21) Appl. No.: 10/074,701

(22) Filed: Feb. 13, 2002

Related U.S. Application Data
(60) Provisional application No. 60/268,738, filed on Feb. 14, 2001.
(60) Provisional application No. 60/281,817, filed on Apr. 5, 2001.

(51) Int. Cl. H04J 1/16; H04J 3/14

(52) U.S. Cl. 370/216; 370/394

(57) ABSTRACT

The present invention provides an automated retransmission request-based system wherein packets are continuously transmitted from a transmitter to a receiver. During reception, the receiver will send either an acknowledgement (ACK) or a negative-acknowledgement (NAK) to the transmitter, depending on whether or not the corresponding packet was properly received. In response to the NAKs, the transmitter will identify the packet that was not properly received, which is referred to as the packet for retransmission. The transmitter will divide the packet for retransmission into multiple subpackets, and puncture each subpacket into a packet in the sequence of packets being transmitted to the receiver. The receiver will recover the subpackets from the punctured packets and will recreate the packet for retransmission from the recovered subpackets.

This application claims the benefit of U.S. provisional patent application Nos. 60/268,738, entitled PARTIAL PUNCTURED RE-TRANSMISSION (PPT) BASED HARQ WITH N-CHANNEL DATA FLOW and filed Feb. 14, 2001, and 60/281,817, entitled NON-COMPLETE PUNCTURE RE-TRANSMISSION BASED HARQ and filed Apr. 5, 2001, the disclosures of which are herein incorporated by reference in their entirety.

### FIELD OF THE INVENTION

The present invention relates to wireless communications, and in particular to controlling retransmission of improperly received information.

### BACKGROUND OF THE INVENTION

In wireless communications systems, continuously varying channel conditions often result in a receiver being unable to properly receive transmitted information. When corrupted, the information is typically retransmitted until it is properly received. The transmitted information is typically sent in predefined packets depending on transmission protocol. Although these units of data may be transmitted directly, most communication protocols incorporate one or more coding techniques to increase the robustness of the transmission and increase the likelihood of the receiver being able to properly recover the transmitted packet. Accordingly, any encoding provided during transmission will require corresponding decoding during reception.

Various types of protocols exist that allow the receiver to inform the transmitter that certain packets were either not received or were corrupted. In response to an indication that a packet was corrupted, the transmitter will retransmit the corrupted packet. Certain communication systems implement an automatic repeat request (ARQ) protocol to provide error control. In general, ARQ-based systems will transmit an acknowledgement (ACK) from the receiver to the transmitter for each packet that is properly received, and send a negative-acknowledgement (NAK) when the receiver is unable to properly recover a packet. The term hybrid ARQ (HARQ) is used when the packets are encoded to facilitate error correction at the receiver.

Although there are numerous variations of ARQ, a common variant is the stop and wait (SAW) ARQ protocol. SAW-based ARQ systems will transmit a packet and wait for an ACK or NAK from the receiver prior to sending the next packet. If a NAK is returned, the previously transmitted packet is retransmitted. If an ACK is received, the next packet is transmitted, and the cycle repeats.

SAW-type ARQ protocols necessarily inject transmission delays because the transmitter must wait for an ACK or NAK from the receiver prior to retransmitting a corrupted packet or transmitting the next packet. HARQ-based systems, which incorporate coding and require the receiver to decode the received packets, inject additional delay in proportion to the processing time required for decoding. Further, SAW-based ARQ systems may stall if persistent errors occur in association with a specific unit of data.

Accordingly, there is a need for an improved ARQ-based protocol that facilitates continuous data transmission while supporting retransmission of corrupted data.

### SUMMARY OF THE INVENTION

The present invention provides an automated retransmission request-based system wherein packets are continuously transmitted from a transmitter to a receiver. During reception, the receiver will send either an acknowledgement (ACK) or a negative-acknowledgement (NAK) to the transmitter, depending on whether or not the corresponding packet was properly received. In response to the NAKs, the transmitter will identify the packet that was not properly received, which is referred to as the packet for retransmission. The transmitter will divide the packet for retransmission into multiple subpackets, and puncture each subpacket into a packet in the sequence of packets being transmitted to the receiver. The receiver will recover the subpackets from the punctured packets and will recreate the packet for retransmission from the recovered subpackets.

In one embodiment, the sequence of packets is encoded at the transmitter using a desired coding scheme, and is decoded at the receiver. The encoded packets will include systematic bits corresponding to the actual data to be transmitted and non-systematic bits corresponding to parity bits that result from coding. Bits for a given subpacket are punctured into another packet by replacing certain of the non-systematic bits with the bits of the subpacket. Preferably, puncturing is evenly distributed throughout the encoded packet.

The present invention is equally applicable to single and multi-user systems. In multi-user systems, subpackets associated with a given user are only punctured into packets being delivered to that user. Further, when the sequence of packets is coming to an end and there are more subpackets than packets being transmitted, the transmitter will preferably retransmit the packet for retransmission in its entirety instead of puncturing packets with corresponding subpackets.

The subpackets may be configured in numerous ways to facilitate recreation of the packet for retransmission. For example, incremental redundancy may be used such that additional redundant information is incrementally transmitted in each subpacket. When the subpackets have provided the receiver with sufficient information to recover the packet for retransmission, no further subpackets are transmitted. The subpackets may also be created using Chase combining techniques. The present invention may also provide a second acknowledgement flow dedicated to providing ACKs or NAKs in association with the proper receipt of subpackets or packets for retransmission.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of packet and acknowledgement (and negative acknowledgement) flows according to one embodiment of the present invention.

FIG. 2 is a block representation of a transmitter and receiver according to one embodiment of the present invention.

FIG. 3 is a representation of a coding matrix according to one embodiment of the present invention.

FIG. 4 is a transmission template based on the coding matrix of FIG. 3.

FIGS. 5A-5J illustrate sequential transmission and reception of retransmitted subpackets according to one embodiment of the present invention.

FIG. 6 illustrates the positioning of data corresponding to a subpacket, which is punctured into a subsequent packet for transmission according to one embodiment of the present invention.

FIG. 7 illustrates communication flow in a multi-user system according to one embodiment of the present invention.

FIG. 8 illustrates communication flow of retransmitted data at the end of a communication session according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

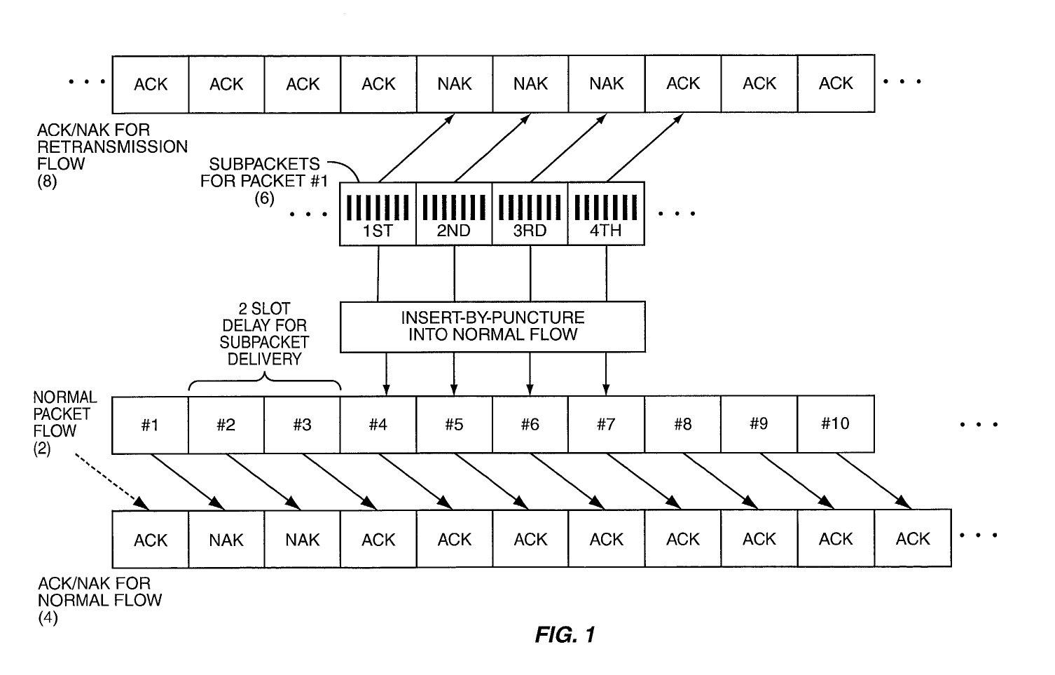

With reference to FIG. 1, a partial puncture HARQ protocol is illustrated according to one embodiment of the present invention. For the purposes of conciseness and consistency, assume that units of data to be transmitted are encoded to create a packet, which is transmitted in whole or in part to a compatible receiver using any acceptable modulation technique. Accordingly, the receiver will demodulate a received signal to recover the packet and subsequently decode the packet to recover the unit of data.

In general, the present invention is triggered to retransmit a packet upon receiving a negative acknowledgment (NAK) from the receiver indicating that the packet was corrupted and not properly received. For retransmission, the packet for retransmission (corrupted packet) is divided into a number of segments, referred to as subpackets. Each subpacket is then injected into a subsequent packet, and transmitted to the receiver. The receiver will recover the subpackets from an incoming sequence of packets, and then assemble each of the subpackets into the packet for retransmission. The packet for retransmission is then decoded to recover the corresponding unit of data. Throughout this process, packets are continuously sent without waiting for some type of acknowledgement. If a NAK is received, the packet associated with the NAK is broken into subpackets and injected into subsequent packets for transmission.

As illustrated in FIG. 1, the normal packet flow 2 is continuous and causes the receiver to generate a continuous acknowledgement stream 4 back to the transmitter, wherein each acknowledgement corresponds to a given packet. The acknowledgement stream 4 will include ACKs and NAKs, depending on whether or not the corresponding packet was properly received. Preferably, a single bit is associated with a packet, wherein a first logic state represents an ACK and a second logic state represents a NAK. Further, the acknowledgement flow 4 incorporates a robust modulation scheme. In the example of FIG. 1, assume that packet #1 in the packet flow 2 was not properly received, and resulted in the receiver sending a NAK to the transmitter. Based on timing or other identification technique, the transmitter will recognize that packet #1 was not properly received based on the NAK. At this point, packet #1 is subdivided into four subpackets 6 (1^{st} subpacket, 2^{nd} subpacket, 3^{rd} subpacket, 4^{th} subpacket). Each of the subpackets 6 are then inserted into subsequent packets #4, #5, #6, and #7, respectively, using a puncturing technique, which is described in further detail below.

The four subpackets are punctured into packets #4, #5, #6, and #7 instead of packets #2, #3, #4, and #5 to illustrate the time delay associated with the time necessary to receive the NAK from the receiver, create the subpackets 6 based on the packet for retransmission #1, and puncture the subpackets 6 into subsequent packets for transmission. Since transmission of a packet is typically associated with a defined time slot, the example illustrated in FIG. 1 depicts a two-slot delay between the time packet #1 is originally sent and the time packet #4, which includes the first subpacket corresponding to packet #1, is transmitted.

As noted, the normal packet flow 2 and the acknowledgement flow 4 are provided on separate communication channels. To further enhance the present invention, a separate retransmission acknowledgement flow 8 may be provided in association with the acknowledgement flow 4 on the same or different channel. The retransmission acknowledgement flow 8 may be used to provide an ACK or NAK based on whether or not the retransmitted packet or subpackets were properly recovered from the punctured packets. The retransmission acknowledgement flow 8 may be used to simply indicate recovery and reception of the retransmitted packet or subpacket, as well as stop the puncturing process when sufficient information is recovered in the previously recovered subpackets to recover the originally corrupted packet. The latter is beneficial when the subpackets implement an incremental redundancy (IR) scheme in which increasingly more information is provided with each subsequent subpacket. As increasing amounts of the packet for retransmission are received, the likelihood of being able to determine what the packet actually was increases.

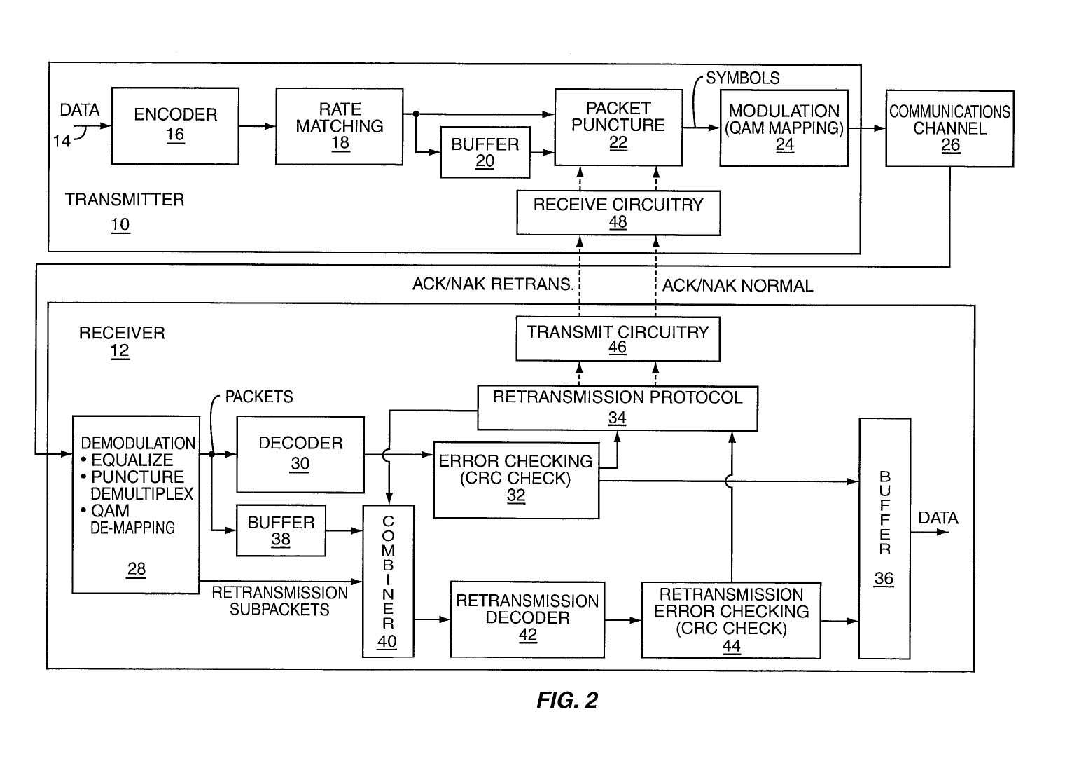

Turning now to FIG. 2, exemplary architectures for a transmitter 10 and a receiver 12 are illustrated according to one embodiment of the present invention. Data 14, typically in the form of streaming bits, are presented to an encoder 16, which encodes units of the data 14 according to a desired coding technique, such as turbo coding. Notably, the coding technique may vary from packet to packet, which changes the number of bits representing a set unit of data. Accordingly, the bit rate changes and rate matching logic 18 cooperates with the encoder 16 such that the proper bits are associated with a given packet depending on the coding scheme. The resultant packets are buffered in a buffer 20 and sent to packet puncture logic 22, which will puncture the packet with subpackets of previously corrupted packets, if necessary. The packet puncture 22 will effectively monitor the normal acknowledgement flow 4 and the retransmission acknowledgement flow 8, if provided, and provide packet segregation and puncturing as described above. The buffer 20 stores the previously transmitted packets and allows the packet puncture logic 22 to access a copy of a corrupted packet upon receiving a NAK via the acknowledgement flow 4.

The packet puncture logic 22 provides all or a portion of the packet in a form ready for modulation. Preferably, this form represents symbols capable of being readily modulated for transmission by modulation circuitry 24. In one embodiment, the modulation circuitry 24 includes quadrature amplitude modulation (QAM) mapping, which maps the symbols into a proper waveform for modulation. The modulated information is sent over a wireless communications channel, represented as block 26, to the receiver 12.

The receiver 12 will typically include demodulation circuitry 28 capable of providing various functions associated with the receiver's front end, as well as certain baseband processing, if necessary, to effectively recover encoded packets. The encoded packets may or may not have been punctured with subpackets, which represent a portion of a previously corrupted packet. The demodulation circuitry 28 will preferably recover the packets, as well as recover any subpackets from the recovered packets. The packets are sent to a decoder 30, which corresponds to the coding scheme provided in the encoder 16 of the transmitter 10. The decoded packets are sent to error checking logic 32 to determine if the decoded packet was properly received. Preferably, a cyclic redundancy check (CRC) algorithm 32 is used to determine the integrity of the decoded packet. If the decoded packet is properly received, it is sent to a buffer 36 in traditional fashion. If the decoded packet is deemed corrupt, the error checking logic 32 will signal the retransmission protocol logic 34 to send a NAK for the decoded packet over the normal acknowledgement flow 4.

The recovered packets from the demodulation circuitry 28 are also buffered in a buffer 38, which is associated with combining logic 40. The combining logic 40 cooperates with the retransmission protocol 34 and receives the retransmission subpackets recovered from the demodulation logic 28 to effectively recombine the subpackets into a complete packet, representing the packet for retransmission. The combining logic 40 may build upon part of a received packet that was buffered in buffer 38, in light of the retransmitted subpackets, or may completely assemble the packet from the retransmitted subpackets.

The combining logic 40 will send the packet for retransmission, which was reassembled or estimated based on the retransmitted subpackets, to the retransmission decoder 42, which will provide decoding corresponding to the coding of encoder 16. Those skilled in the art will recognize that the blocks illustrated in FIG. 2 are logical processing blocks, which may be implemented in the same or any number of hardware, firmware, and software combinations. For example, decoder 30 and decoder 42 may be the same entity or function. The retransmission decoder 42 will attempt to decode the reassembled packet, which is checked for integrity via retransmission error checking logic 44. The retransmission error checking logic 44 operates just as the error checking logic 32, and either provides the decoded, retransmitted packet to the buffer 36 or alerts the retransmission protocol 34 that the reconstructed packet could not be decoded. The retransmission protocol logic 34 may respond in a number of ways, but will preferably control the combining logic 40 to continue to try to reconstruct the packet using subsequently received subpackets. The process will continue until the reconstructed packet for retransmission is properly decoded or the retransmission protocol logic 34 recognizes that the packet cannot be reconstructed given the recovered information. The retransmission protocol 34 may also send ACKs and NAKs corresponding to the retransmitted subpackets via the retransmission acknowledgement flow 8. As those skilled in the art will appreciate, the acknowledgement flow 4 and retransmission flow 8 will be communicated via traditional transmit circuitry 46 of the receiver 12 and receive circuitry 48 of the transmitter 10.

In essence, the normal acknowledgement flow 4, and optionally the retransmission acknowledgement flow 8, is fed back to the packet puncture logic 22 to control retransmission, wherein the retransmission involves dividing corrupted packets into subpackets, puncturing the subpackets into subsequent packets, and transmitting the punctured packets to effect retransmission. Upon receipt of the packets, some of which have been punctured, the receiver 12 will recover the packets, recover the subpackets from the packets, decode normal packets, and reconstruct retransmitted packets from the recovered subpackets. The regularly transmitted packets and the reconstructed (retransmitted) packets are decoded in the same fashion, and are sent to the receiver's buffer 36. Throughout this process, ACKs and NAKs corresponding to the proper reception or the corruption of a packet are fed back to the transmitter 10 to control communications. In a preferred embodiment, the transmitter 10 is an access point, such as a base station, providing high-speed downlink packet access to a mobile terminal, such as a mobile telephone, personal digital assistant (PDA), mobile modem, or the like.

The puncturing technique of a preferred embodiment of the present invention is now illustrated in greater detail. With reference to FIG. 3, a coding (encoding/decoding) matrix is represented, wherein bits represented by the symbol “S” are systematic bits corresponding to the actual data to be encoded. The parity bits resulting from encoding are represented by a “P.” The general order of transmission is column-by-column from the left to the right. Assuming that every bit is transmitted (which is normally not the case), the bits would be transmitted in the following order: S P P P P S P P P P S P P P P . . . The coding matrix represents a code rate (R) of 1/5, wherein for every systematic bit the encoder will effectively generate five bits, which include the systematic bit and four parity bits.

Since transmitting all of the parity bits would unnecessarily load the communication system, the bits are normally transmitted according to a designed template, which may vary from packet to packet, channel to channel, and the like. An exemplary transmission template for coding is illustrated in FIG. 4, wherein the matrix of 1s and 0s represents encoded packet #1. Notably, the 1s represent the positions of bits that will be transmitted, and the 0s represent the positions of bits that will not be transmitted. Accordingly, the information illustrated is a mapping template, and not the actual information transmitted. The information actually transmitted may be 1s or 0s, depending on the data and encoding results. Accordingly, the template (bits actually transmitted) forms the actual packet and is illustrated as being mapped into the block representing packet #1 in the packet flow 6. At this point, packet #1 represents the selected bits of the encoded information that will be transmitted.

Assuming that packet #1 is corrupted and not properly received as illustrated in the example of FIG. 1, a NAK is sent from the receiver 12 to the transmitter 10 to provide such indication. At this point, a copy of packet #1 (according to the transmission template) is recovered from the buffer 20 (shown in FIG. 2) and divided into four subpackets.

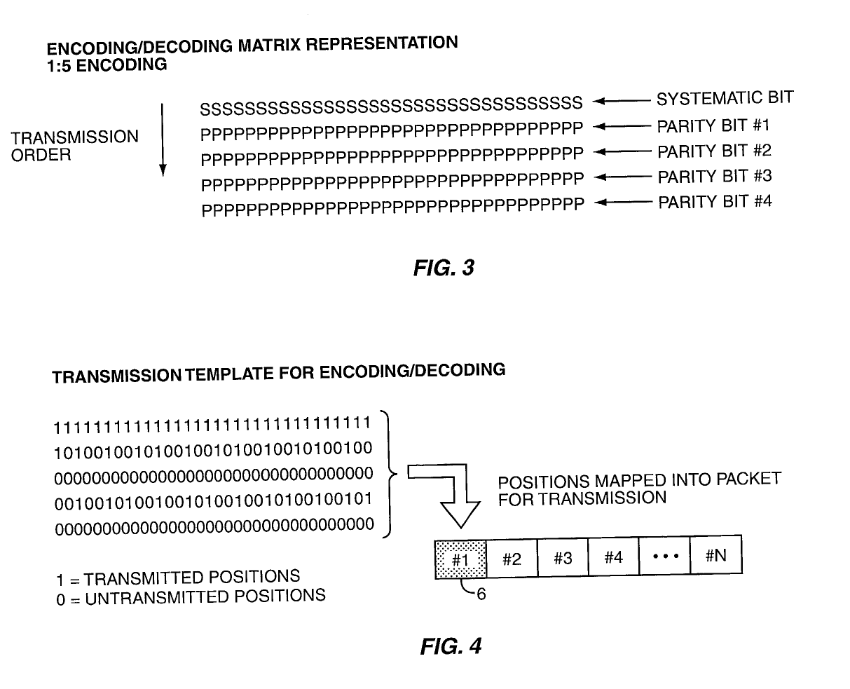

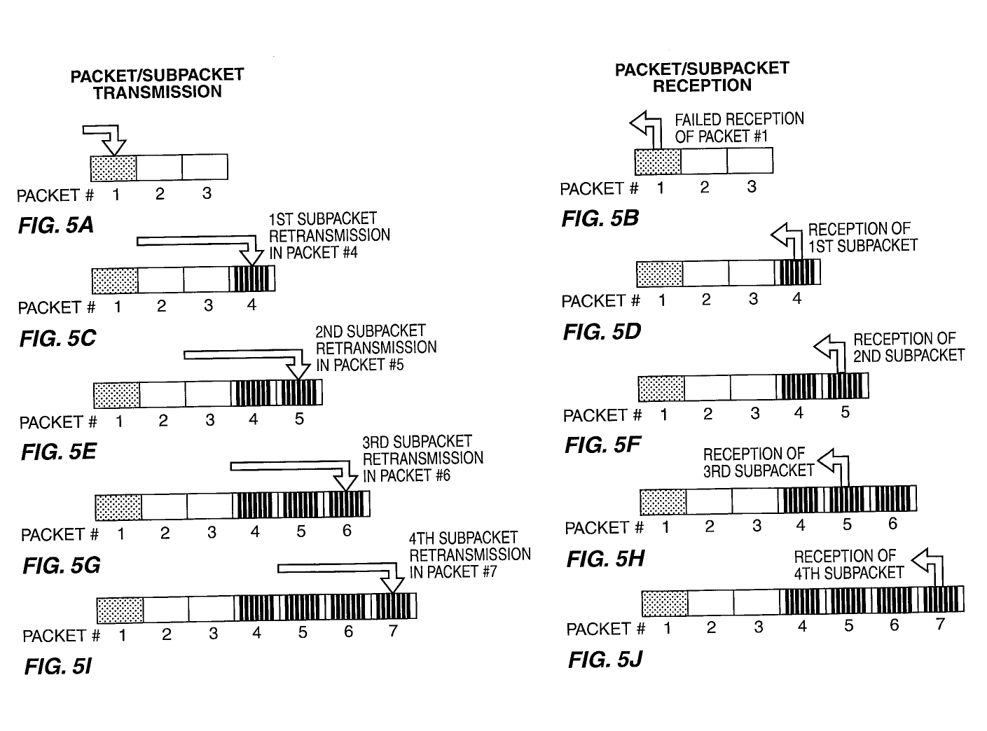

With reference to FIGS. 5A-5J, the puncturing, transmission, and reception of the subpackets and associated punctured packets are illustrated. FIG. 5A represents the initial transmission of packet #1, and FIG. 5B represents the failed reception of packet #1. FIG. 5C represents the puncturing of packet #4 and the transmission of packet #4 after packet #2 and packet #3 have been transmitted. The vertical bars represent the punctured information in a punctured packet. FIG. 5D represents the reception of packet #4 and the recovery of the 1^{st} subpacket. FIG. 5E illustrates the puncturing of the 2^{nd} subpacket into packet #5 and the transmission of packet #5. FIG. 5F illustrates the reception of packet #5 and the recovery of the 2^{nd} subpacket. At this point, the receiver 12 has received packets #2, #3, #4, and #5, and has the 1^{st} and 2^{nd} subpackets to attempt a reconstruction of packet #1. Meanwhile, packet #6 is punctured with the 3^{rd} subpacket and transmitted as illustrated in FIG. 5G. FIG. 5H represents the reception of packet #6 and the recovery of the 3^{rd} subpacket. FIG. 51 represents the puncturing of packet #7 with the 4^{th} subpacket and transmitting packet #7. FIG. 5J represents the reception of packet #7 and the recovery of the 4^{th} subpacket.

At this point, the receiver 12 has received packets #2-7 and has recovered the 1^{st}-4^{th} subpackets, and accordingly, should be able to reconstruct packet #1 from the 1^{st}-4^{th} subpackets. Notably, the number of subpackets illustrated for retransmission is merely for illustrative purposes, and may vary from application to application. Further, as will be described in further detail below, the number of subpackets necessary for retransmission may vary when implemented in systems wherein previously corrupted packets may be recreated with varying numbers of subpackets, depending on channel conditions.

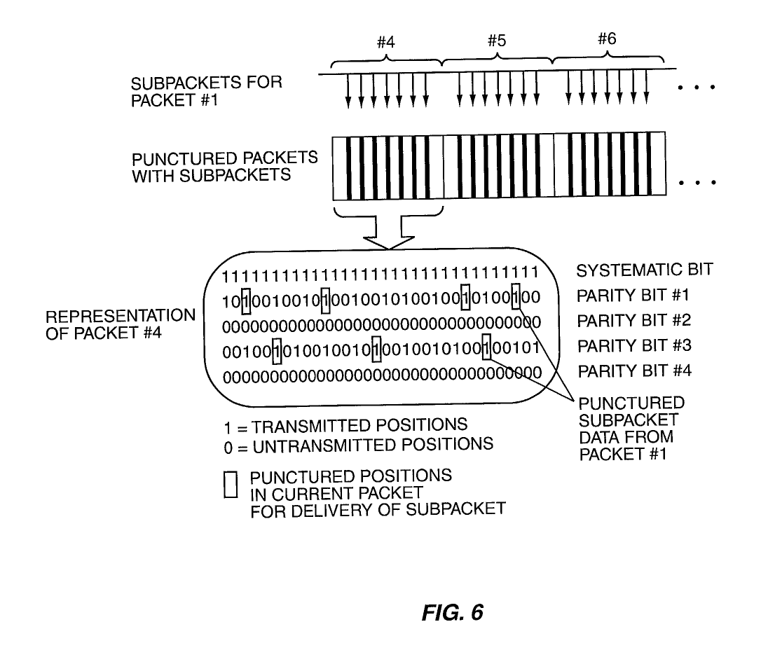

With reference to FIG. 6, packets #4-#6 are each illustrated as being punctured with 7-bit subpackets. Further, an exploded representation of packet #4 is illustrated wherein the highlighted parity bits represent the bits that puncture packet #4. Similar to that described in FIG. 4, a transmission template for packet #4 is provided, wherein the positions represented with a 1 are positions that will be transmitted. Further, seven of these positions are highlighted and represent the positions that are punctured. In this example, there are seven positions that are punctured, corresponding to the seven bits that form the 1^{st} subpacket. Preferably, all of the systematic bits are transmitted and only select ones of the non-systematic (or parity) bits are punctured with the bits forming the subpacket. However, those skilled in the art will recognize that the systematic bits may be punctured. Further, the transmission scheme may be configured to not transmit certain systematic bits.

Those skilled in the art will recognize that the templates may change from packet to packet, and the positions that are punctured may also vary from packet to packet. Preferably, the punctured positions are uniformly distributed throughout the parity bits to minimize the impact on coding and modulation.

Although many forms of combining may be implemented, such as Chase combining, incremental redundancy, and complete retransmission, incremental redundancy is used in the preferred embodiment. For incremental redundancy, the HARQ process incrementally transmits information in addition to redundant information, or information already received. Thereby, the receiver can attempt to decode the retransmitted packet after receiving each subpacket. When enough subpackets are received for decoding, the retransmission process for the corresponding packet is stopped, and transmission of subpacket for a subsequently corrupted packet may begin. Preferably, the incremental redundancy of the present invention has the following characteristics. In each subpacket, a different version of incremental redundancy is transmitted. Each subpacket is uniformly decimated with samples collected from the parity bits of the corrupted packet. Further, each subpacket is uniformly mapped to the parity bits portion of a normal packet using the puncturing described above. Chase combining, which involves retransmitting another copy of the encoded packet, may be used.

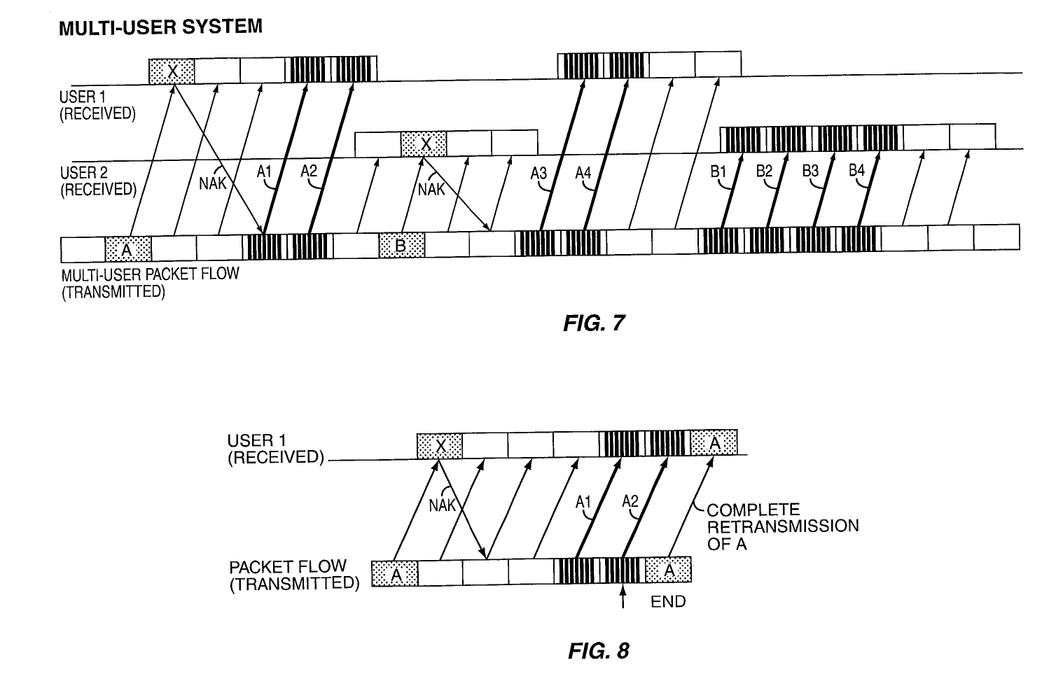

The present invention may be scaled to facilitate HARQ processing in multi-user environments. Although the acknowledgement flows for each user may be intertwined with packets, it is preferred to only provide such flows in association with a particular user, as illustrated in FIG. 7. For example, if a multi-user packet flow attempts to send packet A, which is not properly received at the receiver of user 1, a NAK is sent back to the transmitter, which starts the partial puncture process wherein subpackets A1-A4 are created. As illustrated, the first five packets are intended for user 1, and the fourth and fifth packets are punctured with subpackets A1 and A2, respectively. At this point, packet flow transitions to user 2, wherein the second of user 2's packets, packet B, is corrupted and results in a NAK being sent back to the transmitter. The HARQ process will divide packet B into four subpackets B1-B4 as described above. At this point, the packet flow transitions back to user 1, wherein the next two packets sent to user 1 are punctures with subpackets A3 and A4 to complete retransmission of packet A, wherein the receiver of user 1 can recreate packet A using subpackets A1-A4. Similarly, when the packet flow transitions back to user 2, the first four available packets are punctured with subpackets B1-B4 and are transmitted to the receiver of user 2, wherein subpackets B1-B4 are used to reconstruct the previously corrupted packet B.

With reference to FIG. 8, the present invention also addresses the situation wherein a NAK has been received near the end of a packet flow such that there are not enough additional packets to carry the subpackets to the receiver. In these situations, the previously corrupted packet is simply retransmitted in its entirety.

Those skilled in the art will recognize improvements and modifications to the preferred embodiments of the present invention. All such improvements and modifications are considered within the scope of the concepts disclosed herein and the claims that follow.

What is claimed is:

1. A method for partial puncture retransmission in an automatic repeat request system comprising:
a) continuously transmitting a sequence of packets;
b) receiving an acknowledgment (ACK) from a receiver for each packet that is properly received;
c) receiving a negative-acknowledgment (NAK) from the receiver for each packet that is not properly received;
d) selecting a packet for retransmission corresponding to each packet that is properly received in response to receiving the NAK;
e) dividing the packet for retransmission into a plurality of subpackets; and
f) puncturing packets in the sequence of packets with the subpackets,
wherein the receiver can recover the subpackets from punctured packets in the sequence of packets to recreate the packet for retransmission.

2. The method of claim 1 wherein when puncturing is necessary, punctured packets in the sequence of packets are punctured with one of the plurality of subpackets.

3. The method of claim 1 wherein the sequence of packets is continuously transmitted without regard to receiving the ACK.

4. The method of claim 1 further comprising encoding units of data to create encoded packets, which form the packets in the sequence of packets.

5. The method of claim 4 wherein the encoded packets comprise systematic bits and non-systematic bits and the puncturing step further comprises replacing select non-systematic bits with bits of the subpacket being punctured into the encoded packet.

6. The method of claim 5 wherein the bits of the subpacket are substantially uniformly punctured throughout the encoded packet.

7. The method of claim 1 wherein the bits of the subpacket are substantially uniformly punctured throughout the encoded packet.

8. The method of claim 1 wherein packets in the sequence of packets are transmitted to different users and the subpackets associated with the packet for retransmission to a select user are only punctured into ones of the packets to be transmitted to the select user.

9. The method of claim 1 further comprising retransmitting an entire packet corresponding to the packet for retransmission when there are more subpackets to transmit than packets to puncture.

10. The method of claim 1 wherein the dividing step further comprises sequentially creating the subpackets with incremental redundancy.

11. The method of claim 1 wherein the dividing step further comprises creating the subpackets to facilitate Chase combining.

12. A method for partial puncture retransmission in an automatic repeat request system comprising:
a) continuously receiving a sequence of packets;
b) transmitting an acknowledgment (ACK) to a transmitter for each packet that is properly received;
c) transmitting a negative-acknowledgment (NAK) to the transmitter for each packet that is not properly received;
d) identifying punctured packets in the sequence of packets, the punctured packets punctured with subpackets corresponding to a retransmission packet, which is a packet that was not properly received during a previous transmission;
e) extracting the subpackets from the punctured packets;
f) combining the subpackets to recreate the retransmission packet; and
g) decoding the recreated retransmission packet.

13. The method of claim 12 wherein the punctured packets in the sequence of packets are punctured with one of the plurality of subpackets.

14. The method of claim 12 wherein the packets in the sequence of packets are encoded and further comprising decoding the sequence of packets to recover corresponding units of data.

15. The method of claim 14 wherein the packets in the sequence of packets comprise systematic bits and non-systematic bits and the punctured packets have select non-systematic bits replaced with bits of the corresponding subpackets.

16. The method of claim 15 wherein the bits of the subpacket are substantially uniformly punctured throughout the punctured packet.

17. The method of claim 12 wherein the bits of the subpacket are substantially uniformly punctured throughout the punctured packet.

18. The method of claim 12 wherein the subpackets provide incrementally redundant information necessary to recreate the retransmission packet.

19. The method of claim 12 wherein the subpackets provide information necessary for Chase combining during the combining step.

20. The method of claim 12 further comprising:
a) transmitting a retransmission ACK to the transmitter for each packet for retransmission that is properly received; and
b) transmitting a retransmission NAK to the transmitter for each packet for retransmission that is not properly received.

21. A system for partial puncture retransmission in an automatic repeat request system comprising:
a) transmission and reception circuitry; and
b) processing logic associated with the transmission and reception circuitry and adapted to:
i) continuously transmit a sequence of packets;
ii) receive an acknowledgment (ACK) from a receiver for each packet that is properly received;
iii) receive a negative-acknowledgment (NAK) from the receiver for each packet that is not properly received;
iv) select a packet for retransmission corresponding to each packet that is properly received in response to receiving the NAK;
v) divide the packet for retransmission into a plurality of subpackets; and
vi) puncture packets in the sequence of packets with the subpackets,
wherein the receiver can recover the subpackets from punctured packets in the sequence of packets to recreate the packet for retransmission.

22. The system of claim 21 wherein when puncturing is necessary, punctured packets in the sequence of packets are punctured with one of the plurality of subpackets.

23. The system of claim 21 wherein the sequence of packets is continuously transmitted without regard to receiving the ACK.

24. The system of claim 21 wherein the processing logic is further adapted to encode units of data to create encoded packets, which form the packets in the sequence of packets.

25. The system of claim 24 wherein the encoded packets comprise systematic bits and non-systematic bits and the processing logic is further adapted to replace select non-systematic bits with bits of the subpacket being punctured into the encoded packet.

26. The system of claim 25 wherein the bits of the subpacket are substantially uniformly punctured throughout the encoded packet.

27. The system of claim 21 wherein bits of the subpacket are substantially uniformly punctured throughout the encoded packet.

28. The system of claim 21 wherein packets in the sequence of packets are transmitted to different users and the subpackets associated with the packet for retransmission to a select user are only punctured into ones of the packets to be transmitted to the select user.

29. The system of claim 21 wherein the processing logic is further adapted to retransmit an entire packet corresponding to the packet for retransmission when there are more subpackets to transmit than packets to puncture.

30. The system of claim 21 wherein the processing logic is further adapted to sequentially create the subpackets for a given packet for retransmission with incremental redundancy.

31. The system of claim 21 wherein the processing logic is further adapted to sequentially create the subpackets for a given packet for retransmission to facilitate Chase combining.

32. A system for partial puncture retransmission in an automatic repeat request system comprising:
a) transmission and reception circuitry; and
b) processing logic associated with the transmission and reception circuitry and adapted to:
i) continuously receive a sequence of packets;
ii) transmit an acknowledgment (ACK) to a transmitter for each packet that is properly received;
iii) transmit a negative-acknowledgment (NAK) to the transmitter for each packet that is not properly received;
iv) identify punctured packets in the sequence of packets, the punctured packets punctured with subpackets corresponding to a retransmission packet, which is a packet that was not properly received during a previous transmission;
v) extract the subpackets from the punctured packets;
vi) combine the subpackets to recreate the retransmission packet; and
vii) decode the recreated retransmission packet.

33. The system of claim 32 wherein the punctured packets in the sequence of packets are punctured with one of the plurality of subpackets.

34. The system of claim 32 wherein the packets in the sequence of packets are encoded and the processing logic is further adapted to decode the sequence of packets to recover corresponding units of data.

35. The system of claim 34 wherein the packets in the sequence of packets comprise systematic bits and non-systematic bits and the punctured packets have select non-systematic bits replaced with bits of the corresponding subpackets.

36. The system of claim 35 wherein the bits of the subpacket are substantially uniformly punctured throughout the punctured packet.

37. The system of claim 32 wherein the bits of the subpacket are substantially uniformly punctured throughout the punctured packet.

38. The system of claim 32 wherein the subpackets provide incrementally redundant information necessary to recreate the retransmission packet.

39. The system of claim 32 wherein the subpackets provide information necessary for Chase combining during the combining step.

40. The system of claim 32 wherein the processing logic is further adapted to:
a) transmit a retransmission ACK to the transmitter for each retransmission packet that is properly received; and
b) transmit a retransmission NAK to the transmitter for each retransmission packet that is not properly received.
